(19) United States
(12) Patent Application Publication
(10) Pub. No.: US 2026/0086867 A1
(43) Pub. Date: Mar. 26, 2026

(54) PENALTY-BASED MANAGEMENT OF REQUESTS FOR PROCESSOR-BASED RESOURCES

(71) Applicant: Dell Products L.P., Round Rock, TX (US)

(72) Inventors: Dvir Koren, Nahalal (IL); Guy Fayzak, Givatayim (IL); Tal Abir, Nesher (IL)

(21) Appl. No.: 18/897,058

(22) Filed: Sep. 26, 2024

(51) Int. Cl. G06F 9/50

(52) U.S. Cl. CPC G06F 9/5038; G06F 9/5077; G06F 2209/501; G06F 2209/504; G06F 2209/506

(57) ABSTRACT

Techniques are provided for penalty-based management of requests for processor-based resources. One method comprises obtaining a request, from a given user, directed to a given processor-based resource; determining a penalty associated with the request, wherein the penalty is based on a resource utilization associated with one or more requests directed to the given processor-based resource and wherein the penalty indicates an amount of time that the given user waits before sending at least one additional request to the given processor-based resource; generating a response to the request, wherein the response comprises the determined penalty; and providing the generated response to the given user. The penalty may be determined based on an amount of bandwidth utilized in a designated time interval relative to a configured bandwidth limit for the designated time interval.

### BACKGROUND

The number of input/output (I/O) operations and other requests directed to resources, such as storage resources, processes and/or file systems, often increases significantly over time. One or more secondary I/O operations, for example, may be generated as a result of a user I/O operation. Such secondary I/O operations may consume an undesirable amount of system resources (e.g., device, network, processing and/or memory resources) and can impact the latency associated with user I/O operations and other resource requests.

### SUMMARY

Illustrative embodiments of the disclosure provide techniques for penalty-based management of requests for processor-based resources. An exemplary method comprises obtaining at least one request, from a given user, directed to a given processor-based resource; determining, using at least one processing device, a penalty associated with the at least one request, wherein the penalty is based at least in part on a resource utilization associated with one or more requests directed to the given processor-based resource and wherein the penalty indicates an amount of time that the given user waits before sending at least one additional request to the given processor-based resource; generating a response to the at least one request, wherein the response comprises the determined penalty; and providing the generated response to the given user.

Illustrative embodiments can provide significant advantages relative to conventional techniques. For example, problems associated with managing latency associated with resource requests are overcome in one or more embodiments by determining a penalty associated with a given resource request from a given user, in response to determining that a designated resource utilization has been exceeded, where the penalty indicates an amount of time that the given user waits before sending an additional request.

Other illustrative embodiments include, without limitation, apparatus, systems, methods and computer program products comprising processor-readable storage media.

### BRIEF DESCRIPTION OF THE DRAWINGS

FIG. 1 illustrates a network computing environment that can be configured for penalty-based management of requests for processor-based resources in accordance with an illustrative embodiment;

FIG. 2 illustrates a storage data server of FIG. 1 in further detail in accordance with an illustrative embodiment;

FIG. 3 illustrates a processing of requests directed to a resource in accordance with an illustrative embodiment;

FIG. 4 is a sample table illustrating priority and penalty information for a number of representative request types in accordance with an illustrative embodiment;

FIGS. 5 and 6 are flow diagrams illustrating exemplary implementations of methods for processing requests from a given user in accordance with illustrative embodiments;

FIGS. 7 and 8 illustrate an exemplary processing of requests from a user device directed to a resource in accordance with illustrative embodiments;

FIG. 9 is a flow diagram illustrating an exemplary implementation of a method for determining a penalty for a received request directed to a resource in accordance with an illustrative embodiment;

FIG. 10 illustrates exemplary pseudocode for a penalty calculation process in accordance with an illustrative embodiment;

FIG. 11 is a flow diagram illustrating an exemplary implementation of a method for penalty-based management of resource requests in accordance with an illustrative embodiment;

FIG. 12 illustrates an exemplary processing platform that may be used to implement at least a portion of one or more embodiments of the disclosure comprising a cloud infrastructure; and

FIG. 13 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for penalty-based management of requests for processor-based resources.

In one or more embodiments, the disclosed techniques for penalty-based management of resource requests control a rate of secondary I/O operations (and other I/O operations that may impair the latency of user I/O operations) to reduce an impact on the latency of such user I/O operations. Consider two streams of data, where one data stream may be important, and the other data stream may be less important but can generate a significant amount of data and cause delays for the important data stream. A penalty may be determined for a given request, from a given user, directed to a given resource, where the penalty may be based on a size of one or more requests directed to the given resource and where the penalty indicates an amount of time that the given user must wait before sending at least one additional request. In this manner, the bandwidth is reduced over time, for example, to a designated amount. Further, the resources are not overloaded and the latency of user I/O operations is maintained. In some embodiments, the senders of the requests have consented to participate in the disclosed penalty-based management of resource requests.

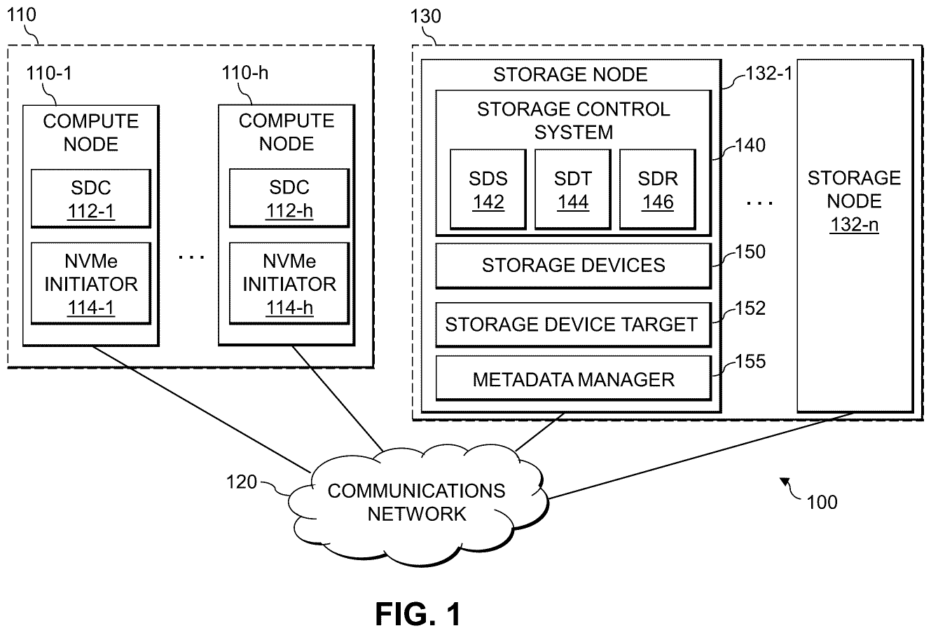

FIG. 1 schematically illustrates a computing environment 100 that can be configured for penalty-based management of resource requests, according to an exemplary embodiment of the disclosure. In particular, FIG. 1 schematically illustrates one or more compute nodes 110-1 . . . 110-h (collectively, compute nodes 110), a communications network 120 and a data storage system 130 comprising a plurality of storage nodes 132-1 . . . 132-n (collectively, storage nodes 132).

In some embodiments, each compute node 110-1 . . . 110-h respectively comprises a storage data client (SDC) 112-1 . . . 112-h and a non-volatile memory express (NVMe) initiator 114-1 . . . 114-h (or NVMe initiator 114), the functions of which will be explained below.

As further shown in FIG. 1, the storage node 132-1 comprises a storage control system 140, storage devices 150, a storage device target 152 and a metadata manager (MDM) 155. In some embodiments, the storage control system 140 is a software-defined storage control system that comprises a storage data server (SDS) 142, a storage data target (SDT) 144 and a storage data replicator (SDR) 146, the functions of which will be explained below. In some embodiments, the other storage nodes (e.g., storage node 132-n) have the same or similar configuration as the storage node 132-1 shown in FIG. 1.

The compute nodes 110 may comprise physical server nodes and/or virtual server nodes that host and execute applications that are configured to process data and execute tasks/workloads and perform computational work, either individually, or in a distributed manner, to thereby provide compute services to one or more users (the term “user” herein is intended to be broadly construed so as to encompass numerous arrangements of human, hardware, software or firmware entities, as well as combinations of such entities, including clients and/or application programming interfaces employed by the user). In some embodiments, the compute nodes 110 comprise application servers, database servers, etc. The compute nodes 110 can include virtual nodes such as virtual machines and container systems. In some embodiments, the compute nodes 110 comprise a cluster of computing nodes of an enterprise computing system, a cloud-based computing system, or other types of computing systems or information processing systems comprising multiple computing nodes associated with respective users. The compute nodes 110 issue data access requests to the data storage system 130, wherein the data access requests include (i) write requests to store data in one or more of the storage nodes 132 and (ii) read requests to access data that is stored in one or more of the storage nodes 132.

The communications network 120 is configured to enable communication between the compute nodes 110 and the storage nodes 132, as well as peer-to-peer communications between the storage nodes 132. In this regard, while the communications network 120 is generically depicted in FIG. 1, it is to be understood that the communications network 120 may comprise any known communication network such as, a global computer network (e.g., the Internet), a wide area network (WAN), a local area network (LAN), an intranet, a satellite network, a telephone or cable network, a cellular network, a wireless network such as Wi-Fi or WiMAX, a storage fabric (e.g., IP-based or Fiber Channel storage fabric), or various portions or combinations of these and other types of networks. In this regard, the term “network” as used herein is therefore intended to be broadly construed so as to encompass a wide variety of different network arrangements, including combinations of multiple networks possibly of different types, that enable communication using, e.g., Transfer Control Protocol/Internet Protocol (TCP/IP) or other communication protocols such as Fibre Channel (FC), FC over Ethernet (FCoE), RDMA over Converged Ethernet (RoCE), Internet Small Computer System Interface (iSCSI), Peripheral Component Interconnect express (PCIe), InfiniBand, Gigabit Ethernet, etc., to implement I/O channels and support storage network connectivity. Numerous alternative networking arrangements are possible in a given embodiment, as will be appreciated by those skilled in the art.

In some embodiments, each storage node 132 comprises a server node (e.g., storage-only node) that is implemented on, e.g., a physical server machine or storage appliance comprising hardware processors, system memory, and other hardware resources that execute software and firmware to implement the functionality of the storage node 132 and the associated storage control system 140. In some embodiments, each storage node 132 comprises a plurality of control processors that execute a lightweight operating system (e.g., a customized lightweight Linux kernel) and functional software (e.g., software-defined storage software) to implement functions of the storage control system 140, as discussed in further detail below.

The storage devices 150 of a given storage node 132 can be internal storage devices and/or direct-attached storage devices, and may comprise one or more of various types of storage devices such as hard-disk drives (HDDs), solid-state drives (SSDs), flash memory cards (e.g., PCIe cards), or other types of non-volatile memory (NVM) devices including, but not limited to, non-volatile random-access memory (NVRAM), phase-change RAM (PC-RAM), magnetic RAM (MRAM), and other types of storage media, etc. In some embodiments, the storage devices 150 comprise flash memory devices such as NAND flash memory, NOR flash memory, etc. The NAND flash memory can include single-level cell (SLC) devices, multi-level cell (MLC) devices, triple-level cell (TLC) devices, or quad-level cell (QLC) devices. These and various combinations of multiple different types of storage devices 150 may be implemented on each storage node 132. In this regard, the term “storage device” as used herein should be broadly construed to encompass all types of persistent storage media including hybrid drives. On a given storage node 132, the storage control system 140 is configured to communicate with the storage devices 150 through any suitable host interface, e.g., a host bus adapter, using suitable protocols such as Advanced Technology Attachment (ATA), serial ATA (SATA), external SATA (eSATA), parallel ATA (PATA), non-volatile memory express (NVMe), small computer system interface (SCSI), serial attached SCSI (SAS), peripheral component interconnect express (PCIe), etc.

The data storage system 130 may comprise any type of data storage system, or a combination of data storage systems, including, but not limited to, a storage area network (SAN) system, a dynamic scale-out data storage system, or other types of distributed data storage systems comprising software-defined storage, clustered or distributed virtual and/or physical infrastructure. The term “data storage system” as used herein should be broadly construed and not viewed as being limited to storage systems of any particular type or types. In some embodiments, the data storage system 130 comprises a dynamic scale-out storage system that allows additional storage nodes to be added (or removed) to the cluster to scale the performance and storage capacity of the data storage system 130. It is to be noted that each storage node 132 and associated storage devices 150 is an example of what is more generally referred to herein as a “storage system” or a “storage array.”

In some embodiments, the data storage system 130 comprises a dynamic scale-out software-defined storage system that is configured to implement a high-capacity block-level SAN storage system (e.g., virtual SAN system) that consolidates the capacity of the storage devices 150 (e.g., HDDs, SSDs, NVMe flash storage, flash PCIe cards etc.) of the storage nodes 132 into shared block storage that is logically partitioned into logical storage volumes identified by, e.g., logical unit numbers (LUNs). In an exemplary embodiment of a scale-out software-defined SAN storage system, the storage control systems 140 comprise software components of a software-defined storage system, that are executed on the storage nodes 132 to implement a software-defined storage environment in which the storage nodes 132 form a loosely coupled storage server cluster and collectively communicate and operate to create a server-based SAN system (e.g., virtual SAN) to provide host access to a virtual pool of block storage using the combined storage capacity (e.g., storage devices 150) of the storage nodes 132.

In some embodiments, the SDCs 112, the MDMs 155, the SDSs 142, the SDTs 144, and the SDRs 146, for example, of the storage nodes 132 comprise software components of a software-defined storage platform, wherein the software components are installed on physical server machines (or server nodes) such as application servers, storage servers, control servers, etc. In some embodiments, virtual machines (e.g., Linux-based virtual machines) are utilized to host the software components of the software-defined storage platform. The software components collectively implement various functions for deploying and managing a software-defined, scale-out server SAN architecture that can grow from a few servers to thousands of severs.

For example, the SDS 142 comprises a service that is configured to manage the storage capacity (e.g., storage devices 150) of a single server (e.g., storage node 132) and provide back-end access to the storage devices of the server. In other words, the SDS 142 is installed on each server that contributes some or all of the capacity of its local storage devices to the scale-out data storage system. More specifically, in the scale-out software-defined storage environment, the SDSs 142 of the storage control systems 140 are configured to create and manage storage pools (e.g., virtual pools of block storage) by aggregating storage capacity of the respective storage devices 150 and dividing each storage pool into one or more volumes, wherein the volumes are exposed to the SDCs 112 of the compute nodes 110 as virtual block devices. For example, a virtual block device can correspond to a volume of a storage pool. Each virtual block device comprises any number of actual physical storage devices, wherein each virtual block device is preferably homogenous in terms of the type of storage devices that make up the block device (e.g., a block device can include only HDD devices or SSD devices, etc.). In this regard, each instance of the SDS 142 that runs on a respective one of the storage nodes 132 contributes some or all of its local storage space to an aggregated virtual pool of block storage with varying performance tiers (e.g., HDD, SSD, etc.) within a virtual SAN.

In some embodiments, each SDC 112 that executes on a given compute node 110 comprises a lightweight block device driver that is deployed to expose shared block volumes to the compute nodes 110. An SDC 112 may expose one or more designated test volumes, discussed further below. In particular, each SDC 112 is configured to expose the storage volumes as block devices to the applications located on the same server (e.g., application server) on which the SDC 112 is installed. In other words, as shown in FIG. 1, the SDCs 112 run on the same server machines as the compute nodes 110 that require access to the block devices exposed and managed by the SDSs 142 of the storage nodes 132. The SDC 112 of a given compute node 110 exposes block devices representing the virtual storage volumes that are currently mapped to the given compute node 110. In particular, the SDC 112 for a given compute node 110 serves as a block driver for the compute node 110, wherein the SDC 112 intercepts I/O requests, and utilizes the intercepted I/O request to access the block storage that is managed by the SDSs 142. The SDCs 112 are installed in the operating system or hypervisor hosting the application layer and provide the operating system or hypervisor (that runs the SDC 112) access to the logical block devices (e.g., volumes). The SDCs 112 have knowledge of which SDSs 142 hold its block data, so multipathing can be accomplished natively through the SDCs 112, where the communications network 120 is configured to provide an any-to-any connection between the compute nodes 110 and the storage nodes 132. More specifically, each SDC 112 connects to every SDS 142, which eliminates the need for multipath software, in at least some embodiments.

In some embodiments, the MDMs 155 implement a management layer on one or more of the storage nodes 132 that manages and configures the software-defined storage system in the computing environment 100. The MDMs 155 are services that function as a monitoring and configuration agent of the storage environment. More specifically, in some embodiments, the management layer is configured to supervise the operations of the storage cluster and manage storage cluster configurations. For example, the MDMs 155 (or an MDM cluster) manage the storage system by aggregating the entire storage exposed to the MDM cluster by the SDSs 142 to generate a virtual storage layer (e.g., virtual SAN storage layer), wherein logical volumes can be defined over storage pools and exposed to host applications as a local storage device using the SDCs 112.

Further, the MDMs 155 are configured to manage various types of metadata associated with the software-defined storage system. For example, such metadata includes a mapping of the SDCs 112 to the SDSs 142 of the storage nodes 132, wherein such mapping information is provided to the SDCs 112 and the SDSs 142 to allow such components to control I/O data path operations (e.g., allow the SDCs 112 to communicate with target SDSs 142 to access data in logical volumes that are mapped to the SDCs 112). In addition, the MDMs 155 collect connectivity status updates from the SDCs 112 to monitor all connections between SDCs 112 and the SDSs 142 to determine the current system state, and post events whenever a given SDC 112 connects to or disconnects from a specific IP address of a given SDS 142.

In addition, the MDMs 155 may be configured to manage various management operations such as data migration, rebuilds, and other system-related functions. In this regard, the MDMs 155 generate and manage various types of metadata that are required to perform various management operations in the storage environment such as, e.g., performing data migration operations, performing rebalancing operations, managing configuration changes, managing the SDCs 112 and the SDSs 142, maintaining and updating device mappings, maintaining management metadata for controlling data protection operations such as snapshots, replication, RAID configurations, etc., managing system capacity including storage device allocations and/or release of capacity, performing operations for recovery from errors and failures, and system rebuild tasks, etc. The MDMs 155 communicate with the SDCs 112 to provide notification of changes in data layout, and communicate with the SDSs 142 to coordinate rebalancing operations. In some embodiments, the MDMs 155 are configured to implement a distributed cluster management system.

In some embodiments, the software-defined storage system utilizes various logical entities that link the physical layer to the virtual storage layer, wherein such logical entities include protection domains, fault sets, and storage pools. In some embodiments, a protection domain is a logical entity that comprises a group of SDSs 142 that provide backup for each other. Each SDS 142 belongs to only one protection domain such that each protection domain comprises a unique set of SDSs 142. In some embodiments, each protection domain can have up to a maximum number of SDS nodes (e.g., 128 SDS nodes). The use of protection domains enables optimal performance, reduction of mean time between failure (MTF) issues, and the ability to sustain multiple failures in different protection domains.

Further, in some embodiments, a fault set is a logical entity that defines a logical group of SDS nodes (within a protection domain) that are more inclined to fail together, e.g., a group of SDS nodes within a given protection domain that are all powered in a same rack. By grouping SDS nodes into a given fault set, the system is configured to mirror the data for all storage devices in the given fault set, wherein mirroring is performed on SDS nodes that are outside the given fault set. A fault unit can be either a fault set or an SDS node that is not associated with a fault set. In some embodiments, user data is maintained in a RAID-1 mesh mirrored layout, where each piece of data is stored on two different fault units. The copies are distributed over the storage devices according to an algorithm that ensures uniform load of each fault unit in terms of capacity and expected network load.

Moreover, in some embodiments, a storage pool is a logical entity that defines a set of physical storage devices in a protection domain, wherein each storage device belongs to only one storage pool. When a volume is configured over the virtualization storage layer, in some embodiments, the volume is distributed over all devices residing in the same storage pool. Each storage pool comprises a homogeneous set of storage devices (e.g., HDD storage pool, or SSD storage pool) to enable storage tiering. In some embodiments, each volume block has two copies located on two different fault units (e.g., two different SDS nodes), that allows the system to maintain data availability following a single-point failure.

The SDR 146 is a software component that is configured to implement a data replication system, e.g., journal-based asynchronous replication. In some embodiments, asynchronous replication is performed between two peer data storage systems, which are connected via a WAN. In general, in some embodiments, asynchronous replication involves writing data to a source (primary) volume in a first data storage system and acknowledging completion of an I/O write operation to a host application before the data is replicated to a target (replica) volume in a second (remote) data storage system (e.g., the source (primary) volume and the target (replica) volume do not share hardware elements in at least some embodiments). With asynchronous replication, the I/O write operations at a source storage node are logged in a replication journal by a source SDR 146 on the source storage node, and the replication journal is periodically transmitted at scheduled times to a target storage node, wherein a target SDR 146 on the target storage node processes the received replication journal to replicate data to a target (replica) volume. The data replication system can be utilized for various purposes including, but not limited to, recovering from a physical or logical disaster, migrating data, testing data at a remote site, or offloading a data backup operation.

More specifically, in the exemplary embodiment of FIG. 1, the SDR 146 is responsible for processing all I/O requests associated with replicated volumes. In the source system, for replicated volumes, the SDCs 112 communicate with the SDR 146. For non-replicated volumes, the SDCs 112 communicate directly with the SDSs 142. At a source storage node, application I/O requests associated with a replicated volume are sent in some embodiments by an SDC 112 to a source SDR 146. The source SDR 146 will write the required journal data to a replication journal volume, and then send a duplicate of the replication I/O write request and associated user data to the SDS 142 wherein the SDS 142 performs write operations to write the received I/O user data in a primary volume. The journal data is then transmitted to a target SDR 146 on a target storage node, which processes the received replication journal to replicate data to the target (replica) volume. In some embodiments, a minimum of two SDRs are deployed on the source and target storage nodes to maintain high availability. If one SDR fails, the management layer (e.g., one or more MDM nodes) directs the SDCs to send the I/O requests for replicated volumes to an available SDR 146.

The SDT 144 can be a front-end target that is a software component configured to provide support for, for example, NVMe-oF, in particular, NVMe over TCP (NVMe/TCP) that enables NVMe-oF across a standard Ethernet network. In some embodiments, the SDT 144 is configured in the storage layer to handle the I/O requests of the NVMe initiators 114 to provide support for the NVMe/TCP storage protocol for front end connectivity, and thus, allow the use of NVMe/TCP hosts in addition to the SDCs 112. In some embodiments, the SDT 144 is an NVMe target that is configured to translate control and I/O data path packets to the NVMe standard protocol, wherein each NVMe initiator 114 is serviced by multiple SDTs 144 depending on the supported number of paths in the NVMe multipathing driver. In essence, I/O requests are sent from a host NVMe initiator 114 (which is installed in the host operating system or hypervisor) to the SDT 144, and the SDT 144 communicates with a target SDS 142 to direct the I/O request to the target SDS 142.

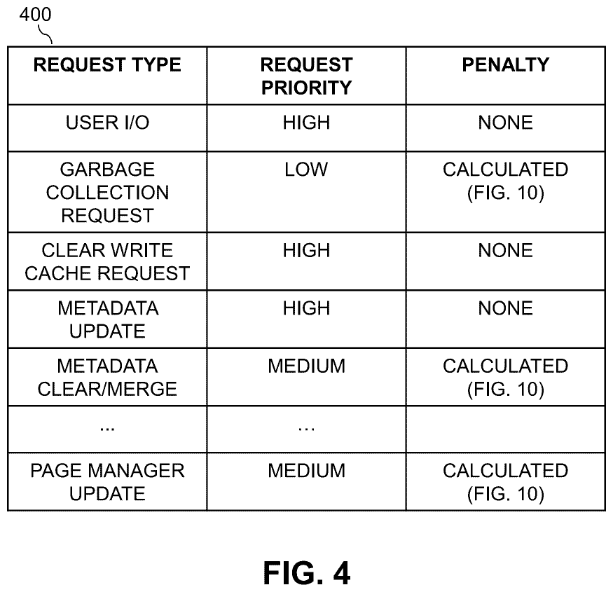

The storage device target 152 of a given storage node 132 can be a backend target configured to manage storage devices 150 and to coordinate a processing of I/O operations on one or more of the storage devices 150, as discussed further below in conjunction with FIG. 4.

A distributed storage system may employ user data storage volumes for storing user data, and metadata storage volumes for storing the metadata corresponding to the user data. The metadata associated with a given SDS may be managed by one or more metadata units. The ownership of the user data storage capacity may be spread among multiple metadata units. The number of metadata units on a given SDS may vary. The different metadata units on an SDS may each have a different number of metadata pages at a given time. In order to provide a scalable system, one or more aspects of the disclosure recognize that the metadata storage volumes should start at a designated size and be expandable to support additional metadata pages.

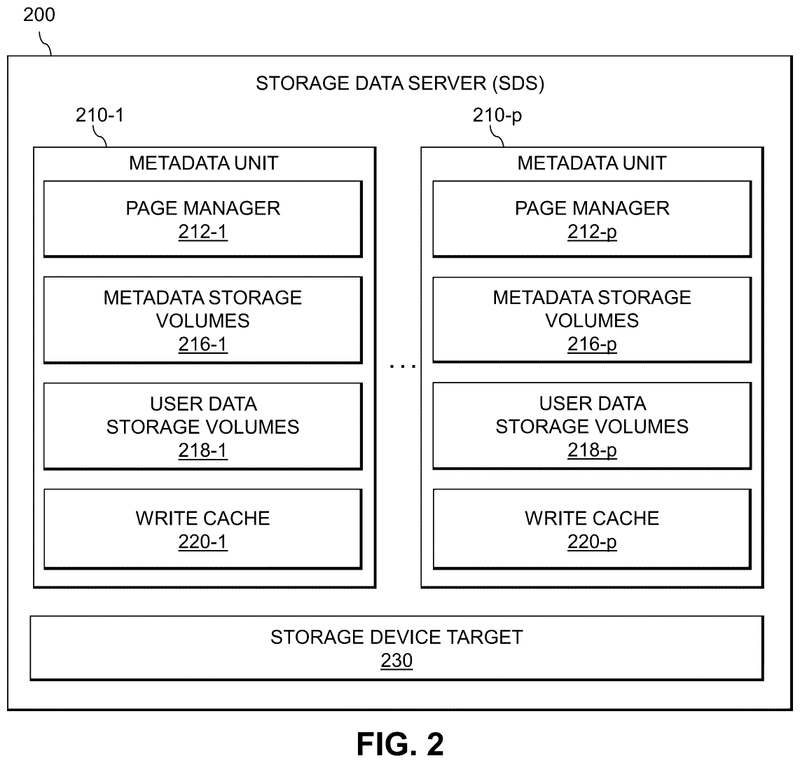

FIG. 2 illustrates an SDS of FIG. 1 in further detail in accordance with an illustrative embodiment. In the example of FIG. 2, an SDS 200 comprises one or more metadata units 210-1. .210-p (collectively, metadata units 210) and a storage device target 230. In some embodiments, metadata unit 210-1 comprises a respective page manager 212-1, one or more metadata storage volumes 216-1, one or more user data storage volumes 218-1 and a write cache 220-1. Similarly, metadata unit 210-p comprises a respective page manager 212-p, one or more metadata storage volumes 216-p, one or more user data storage volumes 218-p and a write cache 220-p. The metadata storage volumes 216 and the user data storage volumes 218 are configured to store metadata pages and user data pages, respectively, and may also store additional information, such as checkpoints and write journals. The write cache 220 may be used to improve performance by using a volatile memory (e.g., RAM) to gather write commands sent to a storage device 150.

As noted above, a storage device target 230 of a given SDS 200 can be a backend target configured to manage storage devices and to coordinate a processing of I/O operations on such storage devices.

The page manager 212 splits the metadata storage volumes 216 into metadata pages (not shown in FIG. 2), and processes requests to allocate and deallocate metadata pages on a metadata storage volume. In some fault scenarios, the page manager 212 may rebuild the metadata stored in one or more of the metadata storage volumes 216. Generally, a metadata page characterizes a plurality of user data pages stored on user data storage volumes 218. For example, in a given set of user data pages, each of the user data pages may be characterized by a storage volume identifier, an offset and possibly a signature.

A given “page” as the term is broadly used herein should not be viewed as being limited to any particular range of fixed sizes. In some embodiments, a page size of 8 kilobytes (KB) is used, but this is by way of example only and can be varied in other embodiments. For example, page sizes of 4 KB, 16 KB or other values can be used. Accordingly, illustrative embodiments can utilize any of a wide variety of alternative paging arrangements for organizing the metadata pages and/or the user data pages.

The user data pages are part of the user data storage volumes 218 (e.g., LUNs) configured to store files, blocks, objects or other arrangements of data, each also generally referred to herein as a “data item,” on behalf of users. The user data stored in the user data pages can include any type of user data that may be utilized in the computing environment 100. The terms “metadata page” and “user data”herein are therefore also intended to be broadly construed.

While one or more embodiments are described herein in connection with I/O requests (including I/O operations generated by applications of a given user and operations directly related to user I/O operations, such as requests to clear a write cache or requests to update metadata or other data structures) associated with the storage environment of FIGS. 1 and 2, for example, the disclosed techniques for penalty-based management of resource requests may be employed in different storage environments, as well as with requests associated with different types of resources, such as requests processed by HTTP servers (e.g., put, post, delete and/or get commands for HTTP servers) or requests processed by other servers, for example, as would be apparent to a person of ordinary skill in the art.

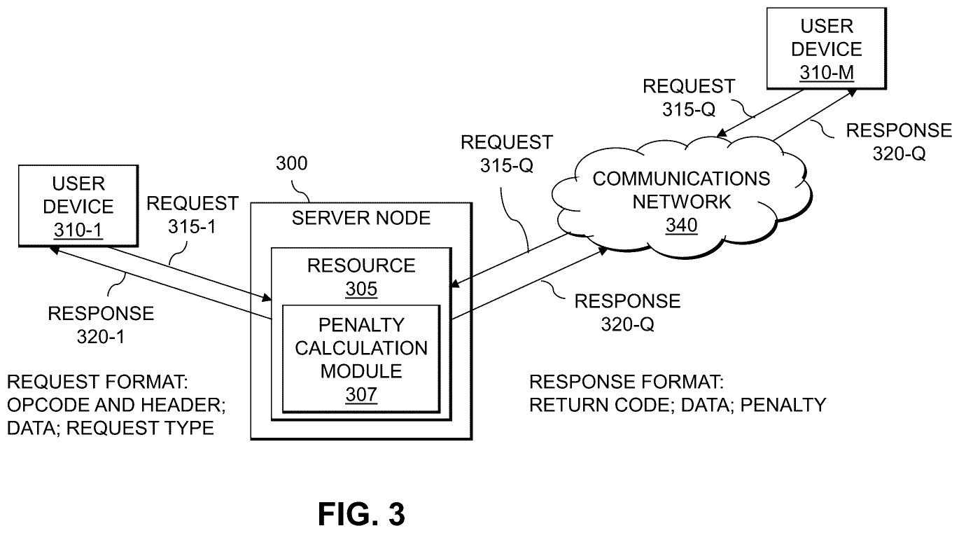

FIG. 3 illustrates a processing of requests 315-1 and 315-Q, directed to a resource 305, by a server node 300 in accordance with an illustrative embodiment. The resource 305 may comprise, for example, a storage resource, such as one or more disks or solid-state drives, a network resource and/or one or more HTTP servers. In the example of FIG. 3, the resource 305 comprises a penalty calculation module 307 that determines a penalty, if any, as part of the disclosed techniques for penalty-based management of resource requests.

The requests 315-1 and 315-Q are generated by one or more user devices 310-1 through 310-M. The user device 310-1 may be associated with an internal user that may be collocated with the server node 300. The user device 310-1 associated with the internal user may generate one or more user I/O operations and/or one or more secondary I/O operations (e.g., having a garbage collection request type). In the example of FIG. 3, the user device 310-1 generates a request 315-1 directed to the resource 305 and receives a corresponding response 320-1 from the resource 305.

In at least some embodiments, the requests 315-1 and 315-Q have a request format comprising an opcode (e.g., an instruction to be executed by the resource 305), header data and a request type. Each request type may be mapped to a corresponding priority and/or one or more rules, as discussed further below in conjunction with FIG. 4. The requests 315-1 and 315-Q may comprise user I/O operations (e.g., read and/or write operations), network packets and HTTP requests (e.g., put, get, post and/or delete operations).

The user device 310-M may be associated with one or more external users that communicate with the server node 300 over a communications network 340. The user device 310-M associated with the external user may generate one or more user I/O operations and/or one or more secondary I/O operations. In the example of FIG. 3, the user device 310-M generates a request 315-Q directed to the resource 305 over the communications network 340 and receives a corresponding response 320-Q from the resource 305.

In one or more embodiments, the responses 320-1 and 320-Q have a response format comprising a return code (e.g., success, failure and/or another return code), data and a penalty, if any. The penalty indicates an amount of time that the given user must wait before sending at least one additional request 315 to the resource 305.

FIG. 4 is a sample table 400 illustrating priority and penalty information for a number of representative request types typically associated with persistent storage devices (e.g., disk drives, solid-state drives, NVMe (Non-Volatile Memory Express) devices and other persistent memory (PMem) storage devices, in accordance with an illustrative embodiment. In the example of FIG. 4, the table 400 indicates, for each request type, a corresponding priority and a penalty, if any, to be employed by the disclosed techniques for penalty-based management of resource requests. In this manner, each request type identified in the table 400 may be mapped to a corresponding priority and/or one or more rules.

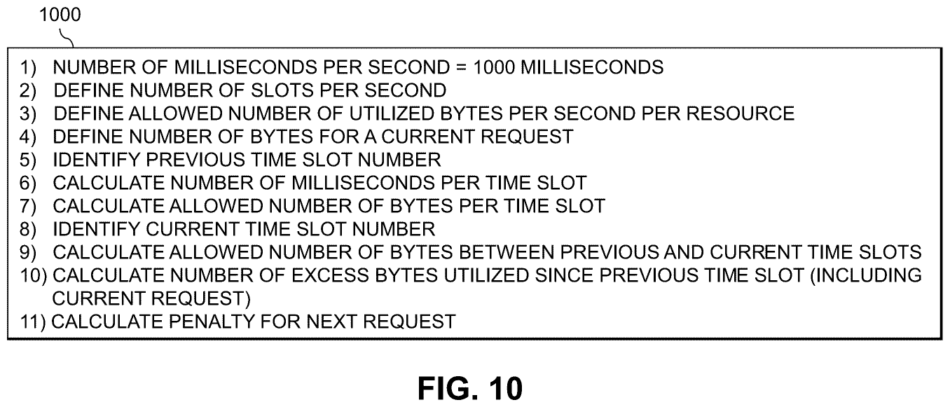

In the embodiment of FIG. 4, one or more designated request types (e.g., user I/O operations, requests to clear a write cache (e.g., write cache 220) and requests to update metadata) do not incur a penalty. In addition, other request types (e.g., secondary I/O operations) have a penalty calculated using the penalty calculation process 1000 of FIG. 10.

In one or more embodiments, device limits and penalties may be separately specified and monitored for each different resource (e.g., device limits and penalties may be considered a property of a resource).

While FIG. 4 illustrates representative request types typically associated with persistent storage devices, the disclosed techniques for penalty-based management of resource requests may be employed to process different requests types in other resources, such as requests processed by HTTP servers (e.g., HTTP requests, backend flush requests and/or read cache prefetch requests, each with a designated priority), requests directed to network resources, requests associated with processing threads and requests for other managed resources, for example, as would be apparent to a person of ordinary skill in the art.

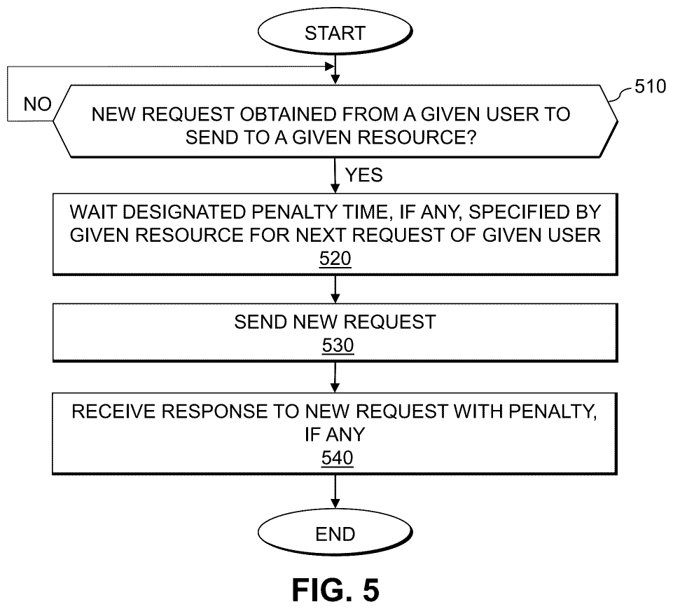

FIG. 5 is a flow diagram illustrating an exemplary implementation of a method for processing, by a given user device (e.g., a device associated with a request generating entity, such as a user or an application), requests from a given user in accordance with an illustrative embodiment. In the example of FIG. 5, a test is performed in step 510 to determine if a new request is obtained from a given user to send to a given resource. If it is determined in step 510 that a new request is not obtained from the given user to send to the given resource, then program control returns to step 510 to continue monitoring for a new request.

If it is determined in step 510 that a new request is obtained from the given user to send to the given resource, then the method of FIG. 5 waits a designated penalty time, if any, in step 520, specified by given the resource (e.g., in the response to the prior request) for the next request of the given user. After the waiting period, if any, the method of FIG. 5 sends the new request in step 530 and receives a response to the new request with a new penalty (e.g., with a waiting period for the given user to send the next request), if any, in step 540. The penalty will be applied by the method 500 to the next request of the given user directed to the given resource.

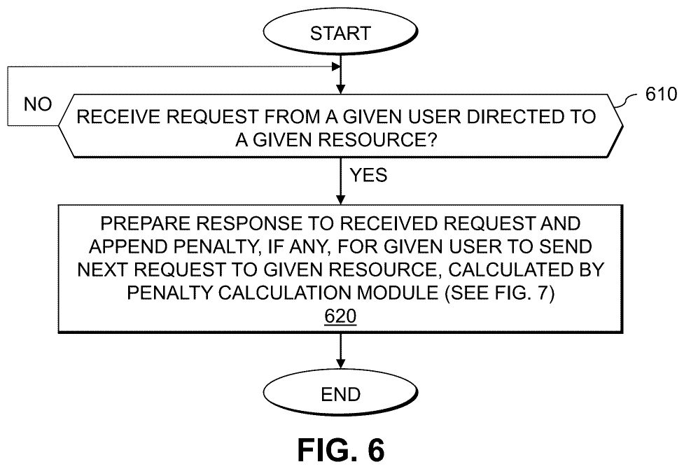

FIG. 6 is a flow diagram illustrating an exemplary implementation of a method for processing, by a server associated with a given resource, requests from a given user in accordance with an illustrative embodiment. In the example of FIG. 6, a test is performed in step 610 to determine if a new request is received from a given user directed to a given resource. If it is determined in step 610 that a new request is not received from a given user directed to the given resource, then program control returns to step 610 to continue monitoring for a new request directed to the given resource.

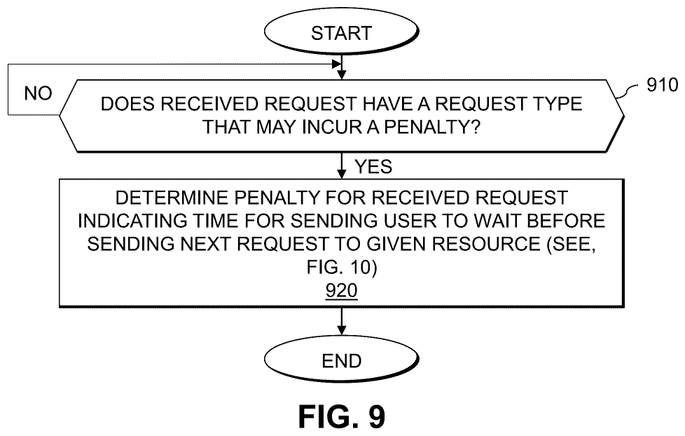

If it is determined in step 610 that a new request is received from the given user directed to the given resource, then a response to the received request is prepared in step 620 (e.g., by the given resource and/or another system entity) and a penalty, if any, is appended to the prepared response for the given user to send the next request to the given resource (e.g., calculated by the penalty calculation module 307 of FIG. 3, as discussed further below in conjunction with FIGS. 9 and 10, for example). As noted above, the appended penalty, if any, indicates a wait time that the given user (or request generating entity) should delay before sending the next request to the given resource.

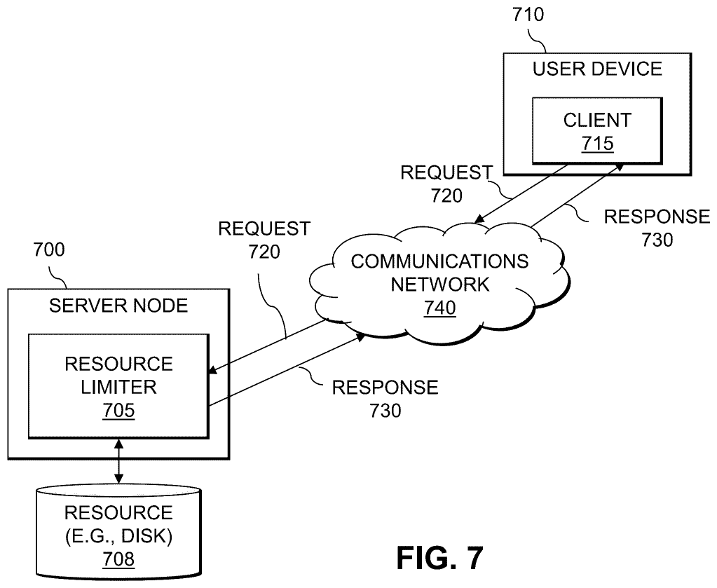

FIG. 7 illustrates an exemplary processing of a request 720, from a client 715 executing on a user device 710, directed to a resource 708 (e.g., a disk), by a server node 700, in accordance with an illustrative embodiment. In the example of FIG. 7, the client 715 of the user device 710 sends the request 720, generated by user device 710, over a communications network 740 to the server node 700. The user device 710 may be associated with, for example, one or more external users that communicate with the server node 700 over the communications network 740. In other embodiments, the user device 710 may be associated with one or more internal users that communicate directly with the server node 700. The user device 710 may generate, for example, one or more user I/O operations and/or one or more secondary I/O operations. The user device 710 may receive a corresponding response 730 to the request 720 from the resource 708.

In the example of FIG. 7, the server node 700 controls access to the resource 708. The server node 700 may comprise a resource limiter 705 that determines a penalty, if any, in accordance with the disclosed techniques for penalty-based management of resource requests. The resource limiter 705 is discussed further below in conjunction with FIG. 10.

In at least some embodiments, the request 720 may have a request format similar to the request format of FIG. 3. The request 720 may comprise one or more user I/O operations (e.g., read and/or write operations), one or more network packets and one or more HTTP requests (e.g., put, get, post and/or delete operations). In addition, the response 730 may have a response format similar to the response format of FIG. 3 (e.g., comprising a return code, data and a penalty, if any). The penalty indicates an amount of time that the given user must wait before sending at least one additional request 720 to the resource 708.

The response 730, potentially comprising a penalty to be paid by the given user, is initially provided to the client 715 of the user device 710. The client 715 pays the penalty, if needed, by waiting the designated amount of time before providing the response 730 (e.g., an acknowledgement of the request 720) to the given user.

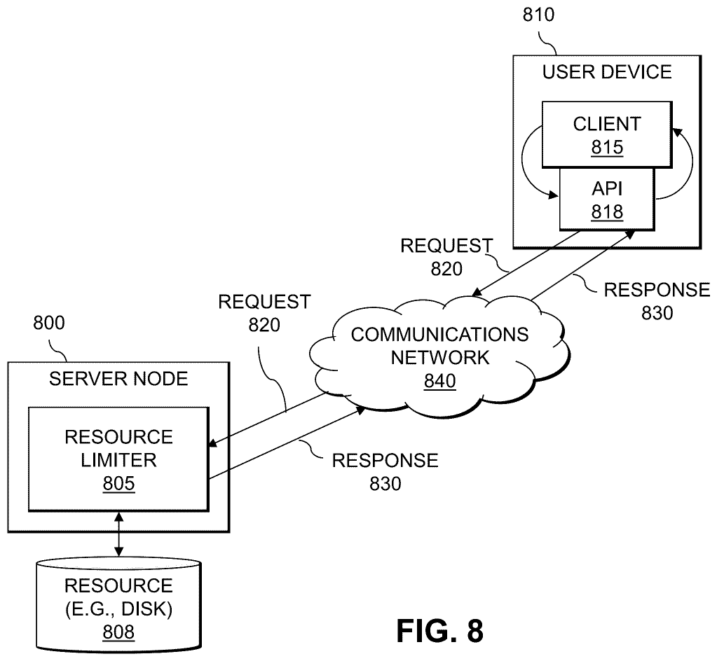

FIG. 8 illustrates an exemplary processing of a request 820, from a client 815 executing on a user device 810, directed to a resource 808 (e.g., a disk), by a server node 800, in accordance with an illustrative embodiment. In the example of FIG. 8, the client 815 of the user device 810 sends the request 820, generated by user device 810, via an application programming interface (API) 818 over a communications network 840 to the server node 800. The user device 810 may be associated with, for example, one or more external users that communicate with the server node 800 over the communications network 840. In other embodiments, the user device 810 may be associated with one or more internal users that communicate directly with the server node 800. The user device 810 may generate, for example, one or more user I/O operations and/or one or more secondary I/O operations. The user device 810 may receive a corresponding response 830 to the request 820 from the resource 808.

In the example of FIG. 8, the server node 800 controls access to the resource 808. The server node 800 may comprise a resource limiter 805 that determines a penalty, if any, in accordance with the disclosed techniques for penalty-based management of resource requests. The resource limiter 805 is discussed further below in conjunction with FIG. 10.

In at least some embodiments, the request 820 may have a request format similar to the request format of FIG. 3. The request 820 may comprise user I/O operations (e.g., read and/or write operations), network packets and HTTP requests (e.g., put, get, post and/or delete operations). In addition, the response 830 may have a response format similar to the response format of FIG. 3 (e.g., comprising a return code, data and a penalty, if any). The penalty indicates an amount of time that the given user must wait before sending at least one additional request 820 to the resource 808.

The response 830, potentially comprising a penalty to be paid by the given user, is initially provided to the API 818 of the user device 810. The API 818 pays the penalty, if needed, by waiting the designated amount of time before providing the response 830 (e.g., an acknowledgement of the request 820) to the client 815 of the given user.

FIG. 9 is a flow diagram illustrating an exemplary implementation of a method for determining a penalty for a received request directed to a resource in accordance with an illustrative embodiment. The method of FIG. 9 may be implemented for a given resource, for example, by a penalty calculation module 307 associated with the given resource.

In the example of FIG. 9, a test is performed in step 910 to determine if a received request has a request type that may incur a penalty. If it is determined in step 910 that a received request does not have a request type that may incur a penalty, then program control returns to step 910 to continue monitoring for a received request type that may incur a penalty.

If it is determined in step 910 that a received request has a request type that may incur a penalty, then the penalty, if any, is determined in step 920 for the received request indicating the time for the sending user to wait before sending the next request to the given resource, as discussed further below in conjunction with FIG. 10.

FIG. 10 illustrates exemplary pseudocode for a penalty calculation process 1000 in accordance with an illustrative embodiment. In some embodiments, the penalty calculation process may be implemented as a limiter process, with a limiter instance for each resource, for example. In some embodiments, a different penalty calculation process (or resource limiter) may be defined for each request type such that each request to the penalty calculation process (or resource limiter) is of the same request type. In this manner, for those request types where no penalty is incurred (e.g., for user I/P operations and other designated request types) the corresponding requests of the designated request types can bypass the penalty calculation process (or resource limiter).

In the example of FIG. 10, the penalty calculation process 1000 recognizes that the number of milliseconds in a second is 1000 milliseconds. In step 2, the penalty calculation process 1,000 defines the number of slots per second (10 slots per second), and the allowed number of utilized bytes per second per resource is defined in step 3 (e.g., 10,000 utilized bytes per second per resource). The number of bytes for a current request is defined in step 4 (such as 500 bytes). The previous time slot number (e.g., 1,233) is identified in step 5.

In one or more embodiments, the penalty calculation process 1000 calculates a number of milliseconds per time slot (such as step 1 value/step 2 value or 1,000/10=100) in step 6 and an allowed number of bytes per time slot in step 7 (e.g., step 3 value/step 2 value or 10,000/10=1,000). The current time slot number (e.g., 1,236) is identified in step 8. The allowed number of bytes between the previous and the current time slots is calculated in step 9 (such as step 7 value * (step 5 value-step 8 value), or 1,000*3=3,000 bytes) and the number of excess bytes utilized since the previous time slot (e.g., including the current request) is calculated in step 10 (e.g., the number of excess bytes utilized for the previous time slot−step 9 value+step 4 value, where assuming previous usage was 4,000 bytes, the new number of excess bytes is 1,500 bytes). The penalty for the next request is then calculated in step 11 (such as applying a round down function to a result of the step 10 value divided by the step 7 value, multiplied by the step 6 value, resulting in 100 milliseconds).

For example, the allowed number of utilized bytes per second per resource specified in step 3 may be 10 MB/sec, and the number of slots per second specified in step 2 may be 10 time slots per second (e.g., divide one second into 10 time slots to allow a given user to spread the I/O operations among the one second). Thus, for every 100 milliseconds (e.g., the time slot size), the data is limited to 1 MB. In some implementations, the I/O size may be 0.5 MB. In the present example, there may be four users sending resource requests. Each penalty will be a multiple of the window size in some embodiments.

In some implementations, a class instance may monitor each given user and monitor the bandwidth utilized over time. Based on the bandwidth already used over a last interval by the given user, the amount of time that a given user needs to “sleep” or “wait” before sending the next I/O operation (or another request type) is calculated (and the current I/O operation is not delayed). The calculated amount of time may be returned with the I/O response to the given user that sent the I/O operation, and the given user waits the requested delay time before sending a new I/O operation (or other request type).

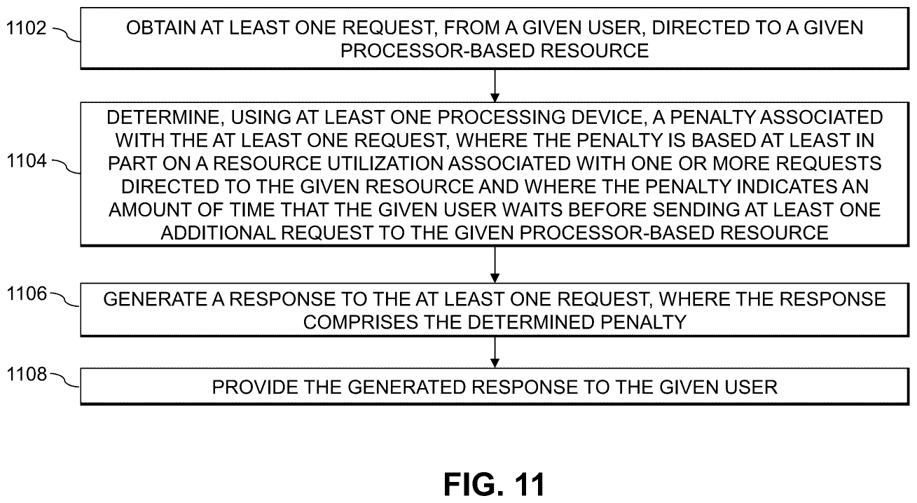

FIG. 11 is a flow diagram illustrating an exemplary implementation of a method for penalty-based management of resource requests in accordance with an illustrative embodiment. In the example of FIG. 11, at least one request, from a given user, directed to a given processor-based resource is obtained in step 1102. A penalty associated with the at least one request is determined in step 1104, using at least one processing device, where the penalty is based at least in part on a resource utilization associated with one or more requests directed to the given processor-based resource and where the penalty indicates an amount of time that the given user waits before sending at least one additional request to the given processor-based resource.

In some embodiments, a response to the at least one request is generated in step 1106, where the response comprises the determined penalty. The generated response is provided to the given user in step 1108.

In one or more embodiments, the at least one request comprises a given request type of a plurality of request types and wherein the penalty is based at least in part on the given request type. The penalty may: (i) cause the given user to transfer a next request without a delay in response to the at least one request being a first request type of the plurality of request types; and (ii) cause the given user to at least delay a transfer of the next request by a determined time interval in response to the at least one request being a second request type of the plurality of request types. A designated penalty duration may be specified for one or more of the plurality of request types. The plurality of request types may comprise one or more primary request types and one or more secondary request types.

In at least one embodiment, the penalty is determined based at least in part on an amount of bandwidth utilized in a designated time interval relative to a designated bandwidth for the designated time interval. The designated bandwidth for the designated time interval may be specified for the given resource.

In some embodiments, the given user comprises one or more of a client that processes at least a portion of the at least one request and an API that processes at least a portion of the at least one request.

The particular processing operations and other network functionality described in conjunction with the flow diagrams of FIGS. 3 and 5 through 11 are presented by way of illustrative example only and should not be construed as limiting the scope of the disclosure in any way. Alternative embodiments can use other types of processing operations for penalty-based management of resource requests. For example, the ordering of the process steps may be varied in other embodiments, or certain steps may be performed concurrently with one another rather than serially. In one aspect, the process can skip one or more of the steps. In other aspects, one or more of the steps are performed simultaneously. The processing of one or more of the steps can also be distributed between multiple components. In some aspects, additional steps can be performed.

In some embodiments, techniques are provided for penalty-based management of resource requests. In at least some embodiments, the disclosed resource request management techniques control a rate of designated requests (e.g., secondary I/O operations and other I/O operations that may impair the latency of user I/O operations, for example) to reduce an impact on the latency of such user I/O operations (or other designated primary requests). In this manner, the bandwidth is reduced over time, for example, to a designated amount. Further, the resources are not overloaded and the latency of user I/O operations (or other designated primary requests) is maintained.

One or more embodiments of the disclosure provide improved methods, apparatus and computer program products for penalty-based management of resource requests. The foregoing applications and associated embodiments should be considered as illustrative only, and numerous other embodiments can be configured using the techniques disclosed herein, in a wide variety of different applications.

It should also be understood that the disclosed resource request management techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for penalty-based management of resource requests may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based resource request management processing engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based resource request management processing platform in illustrative embodiments. The cloud-based systems can include block storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

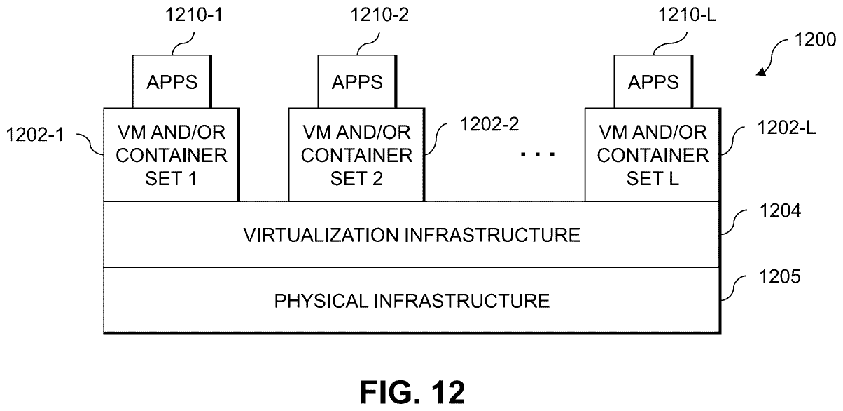

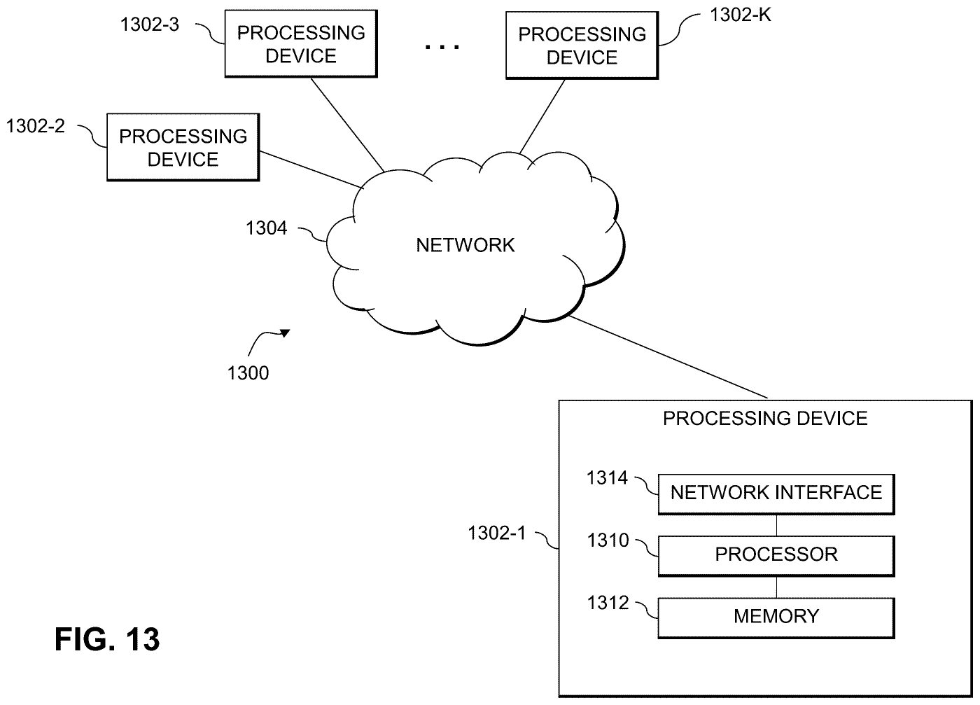

Illustrative embodiments of processing platforms will now be described in greater detail with reference to FIGS. 12 and 13. These platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of an information processing system. The cloud infrastructure 1200 comprises multiple virtual machines (VMs) and/or container sets 1202-1, 1202-2, . . . , 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . , 1210-L running on respective ones of the VMs/container sets 1202-1, 1202-2, . . . , 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. Such implementations can provide resource request management functionality of the type described above for one or more processes running on a given one of the VMs. For example, each of the VMs can implement resource request management control logic and associated functionality for determining penalties indicating an amount of time that a given user must wait before sending another request.

An example of a hypervisor platform that may be used to implement a hypervisor within the virtualization infrastructure 1204 is a compute virtualization platform which may have an associated virtual infrastructure management system such as server management software. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system. Such implementations can provide resource request management functionality of the type described above for one or more processes running on different ones of the containers. For example, a container host device supporting multiple containers of one or more container sets can implement one or more instances of resource request management control logic and associated functionality for determining penalties indicating an amount of time that a given user must wait before sending another request.

As is apparent from the above, one or more of the processing modules or other components of the information processing system may each run on a computer, server, storage device or other processing platform element. A given such element may be viewed as an example of what is more generally referred to herein as a processing device. The cloud infrastructure 1200 shown in FIG. 12 may represent at least a portion of one processing platform. Another example of such a processing platform is processing platform 1300 shown in FIG. 13.

The processing platform 1300 in this embodiment comprises at least a portion of the given system and includes a plurality of processing devices, denoted 1302-1, 1302-2, 1302-3, . . . , 1302-K, which communicate with one another over a network 1304. The network 1304 may comprise any type of network, such as a WAN, a LAN, a satellite network, a telephone or cable network, a cellular network, a wireless network such as WiFi or WiMAX, or various portions or combinations of these and other types of networks.

The processing device 1302-1 in the processing platform 1300 comprises a processor 1310 coupled to a memory 1312. The processor 1310 may comprise a microprocessor, a microcontroller, an application specific integrated circuit (ASIC), a field programmable gate array (FPGA) or other type of processing circuitry, as well as portions or combinations of such circuitry elements, and the memory 1312, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 12 or 13, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining at least one request, from a given user, directed to a given processor-based resource;
determining, using at least one processing device, a penalty associated with the at least one request, wherein the penalty is based at least in part on a resource utilization associated with one or more requests directed to the given processor-based resource and wherein the penalty indicates an amount of time that the given user waits before sending at least one additional request to the given processor-based resource;
generating a response to the at least one request, wherein the response comprises the determined penalty; and
providing the generated response to the given user;
wherein the at least one processing device comprises a processor coupled to a memory.

2. The method of claim 1, wherein the at least one request comprises a given request type of a plurality of request types and wherein the penalty is based at least in part on the given request type.

3. The method of claim 2, wherein the penalty: (i) causes the given user to transfer a next request without a delay in response to the at least one request being a first request type of the plurality of request types; and (ii) causes the given user to at least delay a transfer of the next request by a determined time interval in response to the at least one request being a second request type of the plurality of request types.

4. The method of claim 2, wherein a designated penalty duration is specified for one or more of the plurality of request types.

5. The method of claim 2, wherein the plurality of request types comprises one or more primary request types and one or more secondary request types.

6. The method of claim 1, wherein the penalty is determined based at least in part on an amount of bandwidth utilized in a designated time interval relative to a designated bandwidth for the designated time interval.

7. The method of claim 6, wherein the designated bandwidth for the designated time interval is specified for the given processor-based resource.

8. The method of claim 1, wherein the given user comprises one or more of a client that processes at least a portion of the at least one request and an application programming interface that processes at least a portion of the at least one request.

9. An apparatus comprising:
at least one processing device comprising a processor coupled to a memory;
the at least one processing device being configured to implement the following steps:
obtaining at least one request, from a given user, directed to a given processor-based resource;
determining, using the at least one processing device, a penalty associated with the at least one request, wherein the penalty is based at least in part on a resource utilization associated with one or more requests directed to the given processor-based resource and wherein the penalty indicates an amount of time that the given user waits before sending at least one additional request to the given processor-based resource;
generating a response to the at least one request, wherein the response comprises the determined penalty; and
providing the generated response to the given user.

10. The apparatus of claim 9, wherein the at least one request comprises a given request type of a plurality of request types and wherein the penalty is based at least in part on the given request type, and wherein the penalty: (i) causes the given user to transfer a next request without a delay in response to the at least one request being a first request type of the plurality of request types; and (ii) causes the given user to at least delay a transfer of the next request by a determined time interval in response to the at least one request being a second request type of the plurality of request types.

11. The apparatus of claim 10, wherein a designated penalty duration is specified for one or more of the plurality of request types.

12. The apparatus of claim 9, wherein the penalty is determined based at least in part on an amount of bandwidth utilized in a designated time interval relative to a designated bandwidth for the designated time interval.

13. The apparatus of claim 12, wherein the designated bandwidth for the designated time interval is specified for the given processor-based resource.

14. The apparatus of claim 9, wherein the given user comprises one or more of a client that processes at least a portion of the at least one request and an application programming interface that processes at least a portion of the at least one request.

15. A non-transitory processor-readable storage medium having stored therein program code of one or more software programs, wherein the program code when executed by at least one processing device causes the at least one processing device to perform the following steps:
obtaining at least one request, from a given user, directed to a given processor-based resource;
determining, using the at least one processing device, a penalty associated with the at least one request, wherein the penalty is based at least in part on a resource utilization associated with one or more requests directed to the given processor-based resource and wherein the penalty indicates an amount of time that the given user waits before sending at least one additional request to the given processor-based resource;
generating a response to the at least one request, wherein the response comprises the determined penalty; and
providing the generated response to the given user.

16. The non-transitory processor-readable storage medium of claim 15, wherein the at least one request comprises a given request type of a plurality of request types and wherein the penalty is based at least in part on the given request type, and wherein the penalty: (i) causes the given user to transfer a next request without a delay in response to the at least one request being a first request type of the plurality of request types; and (ii) causes the given user to at least delay a transfer of the next request by a determined time interval in response to the at least one request being a second request type of the plurality of request types.

17. The non-transitory processor-readable storage medium of claim 16, wherein a designated penalty duration is specified for one or more of the plurality of request types.

18. The non-transitory processor-readable storage medium of claim 15, wherein the penalty is determined based at least in part on an amount of bandwidth utilized in a designated time interval relative to a designated bandwidth for the designated time interval.

19. The non-transitory processor-readable storage medium of claim 18, wherein the designated bandwidth for the designated time interval is specified for the given processor-based resource.

20. The non-transitory processor-readable storage medium of claim 15, wherein the given user comprises one or more of a client that processes at least a portion of the at least one request and an application programming interface that processes at least a portion of the at least one request.
